(19) United States
(12) Patent Application Publication
(10) Pub. No.: US 2021/0232703 A1
(43) Pub. Date: Jul. 29, 2021

(54) SYSTEMS AND METHODS FOR DOMAIN-BASED SMART CONTRACT EXECUTION GOVERNANCE IN A DLT NETWORK

(71) Applicant: Insolar Technologies GmbH, Canton of Zug (CH)

(72) Inventors: Kirill Ivkushkin, Moscow (RU); Vladimir Stepanov, Moscow (RU); Pavel Kirillov, Moscow (RU); Andrei Zhulin, Moscow (RU); Petr Fedchenkov, Moscow (RU); Dmitrii Zhulin, Moscow (RU)

(21) Appl. No.: 17/160,659

(22) Filed: Jan. 28, 2021

Related U.S. Application Data
(60) Provisional application No. 62/966,610, filed on Jan. 28, 2020.

(51) Int. Cl. G06F 21/62; G06F 16/27; G06F 21/64

(52) U.S. Cl. CPC G06F 21/6245; G06F 21/64; G06F 16/27

(57) ABSTRACT

Disclosed herein are systems and methods for governing domain-based smart contract execution in a DLT network. In one exemplary aspect, a method may comprise receiving a request to register a first domain in a cloud that comprises nodes of the DLT network and generating the first domain responsive to the request, wherein the first domain comprises a set of smart contracts and policies, e.g. specifically for personal data management, for a first subset of the nodes and wherein a pre-existing second domain in the cloud comprises a different set of smart contracts and policies for a second subset of the nodes. In response to determining to execute the smart contract from the first domain, the method comprises executing a domain policy associated with the first domain, wherein the domain policy determines data privacy settings for the smart contract. The method may comprise executing the smart contract and storing computation results.

### CROSS-REFERENCE TO RELATED APPLICATIONS

This application claims benefit of priority to U.S. Provisional Patent Application No. 62/966,610 filed on Jan. 28, 2020, which is herein incorporated by reference in its entirety.

### FIELD OF TECHNOLOGY

The present disclosure relates generally to the field of distributed ledger technology, more specifically, to systems and methods for governing domain-based smart contract execution in a distributed ledger technology (DLT) network.

### BACKGROUND

In existing distributed ledger technology (DLT) and blockchain systems, smart contracts can only be simple programs, without additional logic like metadata, orchestration, onboarding mechanisms, etc. There is a lack of high level tools for managing complex business logic. Instead, relatively low level programming approaches are employed, requiring large effort to create and manage business solutions. There thus exists a need for facilitating complex business logic through high level abstractions rather than by general programming approaches. In particular, privacy compliance solutions based on the distributed ledger technology would entail a lot of custom development with low level tools (individual smart contracts), without higher level instruments to manage common business logic. For example, policies of data storage should be imposed on all relevant instances of smart contracts, and currently there is virtually no possibility to implement that except by amending all relevant smart contracts or constructing management services external to the DLT.

### SUMMARY

To address these shortcomings, aspects of the disclosure describe methods and systems for governing domain-based smart contract execution in a DLT network.

In one exemplary aspect, a method may comprise receiving a request to register a first domain in a cloud that comprises nodes of the DLT network. The method may comprise generating the first domain responsive to the request, wherein the first domain comprises a set of smart contracts and policies for a first subset of the nodes and wherein a pre-existing second domain in the cloud comprises a different set of smart contracts and policies for a second subset of the nodes. The method may comprise determining whether to execute a smart contract from the first domain or a different smart contract from the second domain. In response to determining to execute the smart contract from the first domain, the method may comprise executing a domain policy of the set of smart contracts and policies associated with the first domain, wherein the domain policy determines data privacy settings for the smart contract. The method may comprise executing the smart contract, and storing computation results from the executing of the smart contract on a ledger of the DLT network.

In some aspects, the domain policy further defines onboarding and membership rules for the first domain.

In some aspects, the domain policy further defines security policies comprising information on at least one of: access rights, authentication settings, authorization, and data sharing.

In some aspects, the domain policy defines rules of consent and regulation-dependent personal data processing.

In some aspects, the consent and regulation-dependent personal data processing comprises storing data in a particular geographic location, data retention or sharing the data with third parties.

In some aspects, the domain policy further defines regulatory mechanisms indicating particular data that may be disclosed to smart contracts of the first domain and data that may be erased or scrambled on the ledger.

In some aspects, the domain policy further defines contract policies comprising rules for adoption, exclusion, and amendment of smart contracts.

In some aspects, the domain policy further defines dynamic consensus rules for adjusting required liability to validate versus defined value at risk of an operation.

In some aspects, the domain policy further defines metadata governance such as registries of the nodes, contracts, and reference data.

In some aspects the domain policy further defines storage policies for processing and storing particular data.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for maintaining and storing a distributed ledger of records.

FIG. 2 is a block diagram of a system illustrating the Insolar platform.

FIG. 3 is a block diagram of a system illustrating domains on a single cloud on the Insolar platform.

FIG. 4 is a block diagram of a system illustrating domains on multiple clouds on the Insolar platform.

FIG. 5 is a block diagram of a system illustrating communication over multiple clouds.

FIG. 6 is a block diagram of a system implementing a personal data privacy solution.

FIG. 7 is a block diagram illustrating interactions with the Insolar Privacy Domain by data subjects and developers.

FIG. 8 is a block diagram of smart data.

FIG. 9 is a flow diagram of a method for governing domain-based smart contract execution in a DLT network.

FIG. 10 is a block diagram of a computer system on which the disclosed system and method can be implemented according to an exemplary aspect.

### DETAILED DESCRIPTION

Exemplary aspects are described herein in the context of a system, method, and computer program product for governing domain-based smart contract execution in a DLT network. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

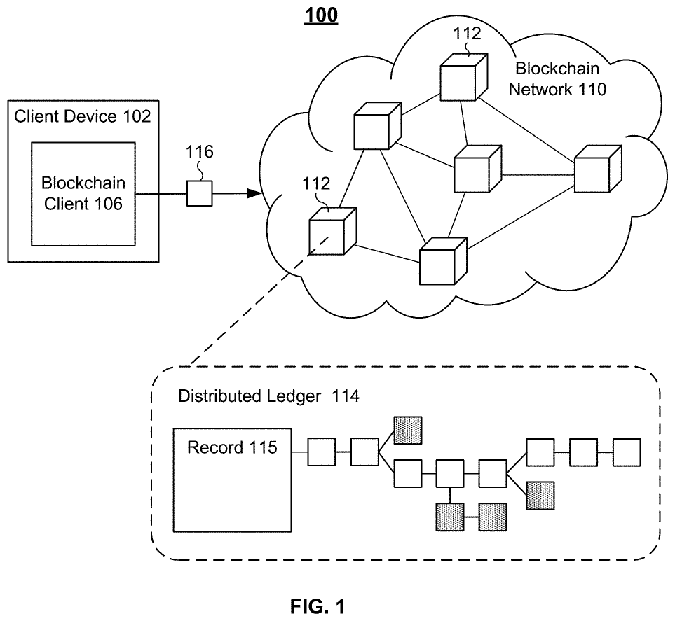

FIG. 1 is a block diagram of system 100 for maintaining and storing a distributed ledger of records, according to an exemplary aspect. System 100 may include one or more client device(s) 102 communicatively connected to blockchain network 110. Client device 102 may be one of personal computers, servers, laptops, tablets, mobile devices, smart phones, cellular devices, portable gaming devices, media players or any other suitable devices that can retain, manipulate and transfer data. Client device 102 may include a blockchain client 106, which is a software application configured to generate and transmit one or more blockchain-based transactions or messages 116 to blockchain network 110 for accessing or modifying records stored in the distributed ledger, such as maintaining user accounts, the transfer of cryptographic assets to and from such user accounts, and other types of operations. Examples of blockchain software platforms may include Insolar, Ethereum, EOS, VeChain, etc.

According to an exemplary aspect, blockchain network 110 can be a distributed peer-to-peer network formed from a plurality of nodes 112 (computing devices) that collectively maintain distributed ledger 114, which may contain one or more blockchains 114. Examples of blockchain network 110 may include an Insolar-based network, an Ethereum-based network, an IBM blockchain-based network, etc. For purposes of the present discussion, the terms distributed ledger and blockchain may be interchangeably used. Blockchain 114 is a continuously-growing list of data records hardened against tampering and revision using cryptography and is composed of data structure blocks that hold the data received from other nodes 112 or other client nodes, including the client device 102 executing an instance of the blockchain client 106. In some aspects, the blockchain client 106 is configured to transmit data values to the blockchain network 110 as a transaction data structure 116, and nodes 112 in the blockchain network record and validate/confirm when and in what sequence the data transactions enter and are logged in blockchain 114. In some aspects, client device 102 sends request 116 to a smart contract (not shown) which is executed/validated by nodes 112, resulting in record 115 that is stored in blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shared chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of jet blocks without compromising data immutability.

Distributed ledgers (e.g., blockchain 114) are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to. Blockchain 114 is configured such that record 115 contained in the blockchain contains a reference to a previous record and hash information.

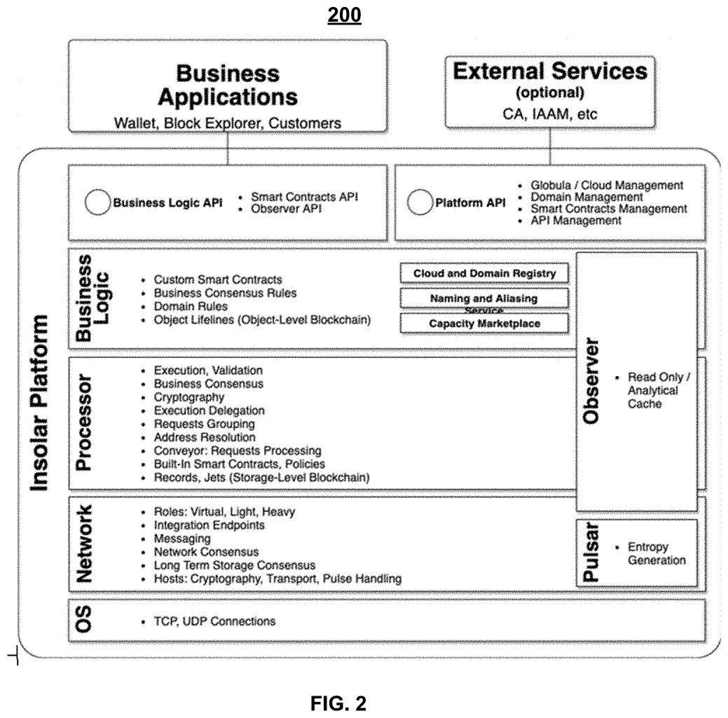

FIG. 2 is a block diagram of system 200 illustrating the Insolar platform, according to exemplary aspects of the present disclosure. In some aspects, the Insolar platform is built on an open system featuring TCP and UDP connections. On top of the open system lies the network. The network is the infrastructure layer (i.e., hardware) in which nodes may take roles such as virtual (for processing), light and heavy (for storage). Processing by the nodes is performed with respect to pulses (i.e., network cycles and entropy) and network consensus (e.g., agreement between network participants).

The processor accounts for ledger(s) and virtual machine(s) (VMs). The ledger comprises lifelines and/or sidelines, which are sequences of records representing objects' states which are produced by smart contracts. Ledgers also comprise jets and jet drops, which are logical units of storage, formed from lifelines. In some aspects, ledgers comprise short term storage (light material nodes) and long term storage (heavy material nodes) persisting of jets for short (frequently changed and accessed) and long (rarely changed and accessed) periods of time, respectively.

A VM is an environment for performing computations, i.e., executing and validating smart contracts. In some aspects, a VM of the Insolar platform is built in Golang, but may support any language (e.g., Java). The VM features support for Interface Definition Language (IDL) and pluggable extensibility to support different cryptography libraries. The VM may support domains as ‘super-contracts’ governing other smart contracts.

Smart contracts may invoke each other by sending message-based requests. There could be several options of processing those requests. In synchronous calls, a caller waits for the result or checks the status of request's execution before continuing with their remaining operation. In asynchronous calls, a caller may continue with their operation after sending the request, and may periodically check the status afterwards. In transactional calls, a caller and a callee are involved in a communication that may be applied only as a whole, so that all involved objects change their states consistently according to business rules. The ‘transactional’ model allows for building complex business interactions involving several different smart contracts.

Smart contracts are executed by the VM and the results of computation are passed to the ledger that forms blockchains and persists (i.e., stores) them. This is all transparent to the end user, and thus complexity is abstracted away by the platform.

On top of the processor is business logic. Business logic may include services such as the Naming and Aliasing Service (NAS), which maps callable labels (aliases) to contracts, like, human readable name for contracts. Another service includes the Cloud and Domain Registry (CDR), which registers and addresses mechanisms for contracts and clouds. Another service is the Capacity Marketplace (CMKT), which is an open market for buying and selling processing resources.

Above business logic are APIs for business applications and external services. Applications (e.g., Wallet) consist of two parts: specific smart contracts in the Platform as a back-end, and middle- and/or front-end. Specific smart contracts are aimed at providing immutable storage for business objects, as well as methods for updating their state. They facilitate (with the help of the Platform) providing a set of APIs for executing those methods. All non-trivial business functionality for manipulating complex objects on the DLT are provided in such a way.

The middle and front may contain arbitrary business logic to facilitate user experience, are completely external to the Platform and are treated as such. They are built separately, and they use the Platform API (and usually, but not necessarily the Observer for read-only operations) to access business objects. They must rely on the Platform as a provider of persistent immutable storage, as well as basic properties and behaviors of business objects.

An observer is a combination of the following components: (1) replicators and collectors for pulling the information out of the Ledger (more specifically, using the replication protocols of the Platform) and combining the information according to the rules defined by the business logic, (2) a relational database that stores the aggregated information and (3) an API for facilitating fast reading from the database.

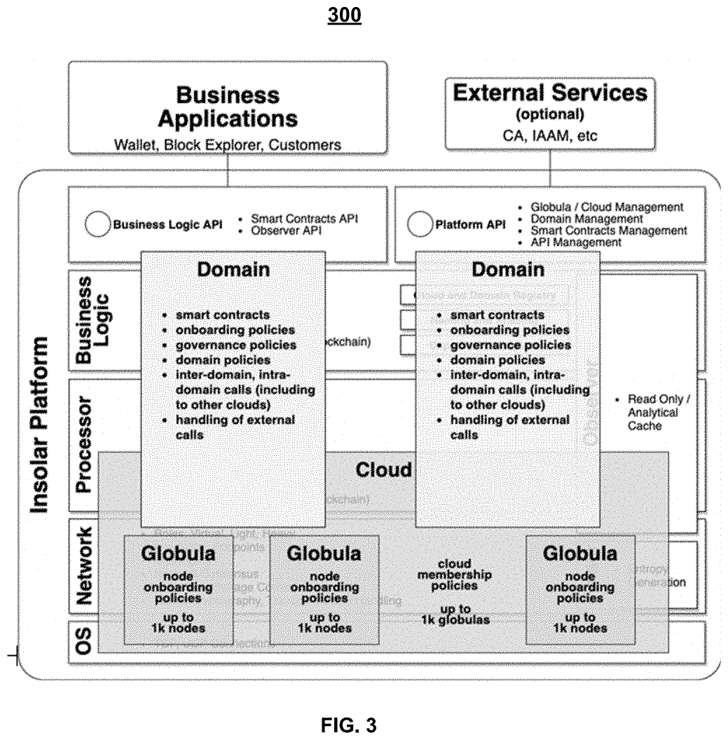

FIG. 3 is a block diagram of system 300 illustrating domains on a single cloud on the Insolar platform, according to exemplary aspects of the present disclosure. A cloud is a set of rules that manages nodes and provides hardware capacity from hardware providers and services in a unified manner. A cloud is a separate network that may be built and managed by using Insolar platform instruments. Clouds can be configured in a customized fashion. In general, clouds may fall in one of two network types: Private and Public.

For both types of networks, there exist node membership rules. The platform requires each hardware provider to be tied to each node, so that the provider gets their fees and answer claims. This is because if a hardware provider manipulates results, the provider must be pinpointed and punished.

In a public network, membership within the domain can be permissioned (i.e., restricted) or permission-less (i.e., open to anyone, but with the domain rules defining membership and sanctions for misbehaving members). In a public network, entities may act as hardware providers or application consumers, each with different stakes and incentives.

In a private network, the owners (e.g., a consortia) provide the setup themselves (act as hardware providers as well as application consumers).

As depicted in system 300, a single cloud may comprise multiple Globula. A Globula is a network of up to 1,000 nodes. A Globula may run as a decentralized network with consistency established by a Byzantine Fault Tolerance (BFT)-based consensus mechanism, implemented as the Globula Network Protocol (GNP).

Clouds may also comprise domains. Domains have a wide range of features based on declared policies that are imposed on every domain participant (e.g., a smart contract) and may be applied in several ways. Domains define generic processes, standards, work rules, data formats, procedures for introducing changes into standards, and procedures for implementing changes (e.g., ITU standards or legal requirements for processing personal data), in addition to initiating and managing objects such as market reference data, code dictionaries, and company registers. Moreover, domains provide and manage transfer and storage policies of protected data (e.g., personal and biometric data, history of clients' financial transactions) and establish access policies to and from objects outside the domain, in addition to cryptography standards, and terms for calculating computing power consumption and storage volume.

Domains are defined as governance units enforcing the aforementioned policies and standards, and may be implemented as programs or objects that manage other programs or objects. For example, all calls to all managed objects may be redirected first to the governance objects provided by the domain, and this may be realized through delegation, inheritance, or composition mechanisms. The platform that is described in the present disclosure intends specifically to use delegation mechanisms between managed and managing smart contracts. However, smart contracts are essentially computer code executed by the platform, and so the domain concept can be implemented through more traditional mechanisms (e.g., service oriented).

When setting a domain, users can define rules, restrictions, and policies, including (1) who can call smart contracts, (2) whether smart contract code can be changed (and by whom), (3) how smart contracts are validated, and (4) data restrictions, which are especially pertinent for regulations such as General Data Protection Regulation (GDPR), California Consumer Protection Act.

In the case of validation, domain owners can decide how many validators are required to approve the executed smart contract, what type of consensus should work between the validators, and what the requirements are for the validators themselves (e.g., whether their identities should be verified or they should be located in a certain jurisdiction).

Domains serve as a unit of governance, and customize policies regarding security, storage and processing, as well as business logic that may be implemented (i.e. ‘super-smart-contracts’). Domains may define onboarding/membership rules for adoption or exclusion of members in a domain. Domains may define security policies such as access rights, authentication settings, authorization (e.g., which members can perform certain tasks with which smart contracts), and data sharing policies (e.g., what members can grant to other members). Domains may define regulatory mechanisms such as the ability to disclose particular data to members with special roles and the ability to consistently erase or scramble particular data stored in a blockchain. Domains may define contract policies such as the adoption, exclusion, and amendment of smart contracts. Domains may define dynamic consensus rules such as adjusting required liability to validate versus defined value at risk of an operation, and defining algorithms of validation (e.g., x-PoS, ‘all-or-nothing,’ etc.). Domains may define metadata governance such as registries of members, contracts or nodes, and reference data (e.g., calendars, units of measurements). Domains may define computation and storage policies such as rules for processing and storing particular data (e.g., geographical location for personal data).

Another example of domain policy is with data encryption. Since different countries have different encryption standards, the domain manager is free to set cryptography standards that are compliant with their local regulators. Domain policy is applied before smart contracts are executed and domain policy determines the data privacy settings (e.g., for the smart contracts and/or for the nodes that run the smart contracts).

Some business processes are better suited to run on public spaces, while others require strict privacy. Accordingly, a domain may be permission-less or permissioned (with customized settings that align with the unique needs of the domain owner). A permissioned domain is a domain where both smart contract execution and data storage is handled by company-owned nodes that may not be visible to outside nodes, nor are they reachable by direct address. More specifically, smart contract execution and data storage are governed by specific restricted rules regarding the access to objects. Permissioned domains are not isolated from other networks (and other permissioned domains). Domains contain smart contracts. can call each other both within a single domain or between different domains (including ones in different clouds), using the naming and addressing mechanisms.

The policies that can be set within domains (e.g., permissioned domains) may include the ability to erase a portion of an object's data. Data erasure can be executed on the Insolar network, ensuring that no third party keeps any personal data after their legitimate access to the personal data has expired. If the data has to be erased in old blocks and rules of a domain allow such erasure, instead of the old records, a hash and the reason of erasure of the record of the erased records appears with the message that the data has been erased according to GDPR or other regulatory requirements.

For personal data management, the domain may provide a class (e.g., a smart contract class) that realizes personal data in such a way that an instantiated object would only contain metadata (and not actual data) on what types of personal information is located and stored elsewhere, with pointers to external storages. For example, the first and last names, email address, and social security number of a person can be stored in the CRM system outside of the platform described herein, and the object managed by the domain would only contain reference to the types (first/last name, email, SSN) and to the external system (CRM). The object would also store types of consents the person has given on usage of their data upon registration with the platform. Whenever the object is accessed, the domain logic would check whether this particular person has given the appropriate consent for the operation in question. If or when the logic of consent processing is changed, such as during a change of the regulation (e.g., the transition from CCPA to CRPA), the new logic would be implemented and uploaded to the domain and not to each and every instantiated object which is subject to the regulation. If the consent is present and valid, the domain would then pass the call to the external system, or otherwise facilitate the request in question. This would give application developers the flexibility in updating the regulatory related business logic, shorten time to market, and increase scaling ability.

In another example, companies may require blockchain solutions to establish interconnected processes with counterparties or within their own structure (among departments, employees), without sharing sensitive data. Moreover, within a single company there could be completely different requirements relating to different processes. For instance, handling thousands of typical records within a shared database is different from securing a contract worth a million dollars, and companies are willing to set different levels of data security for both cases.

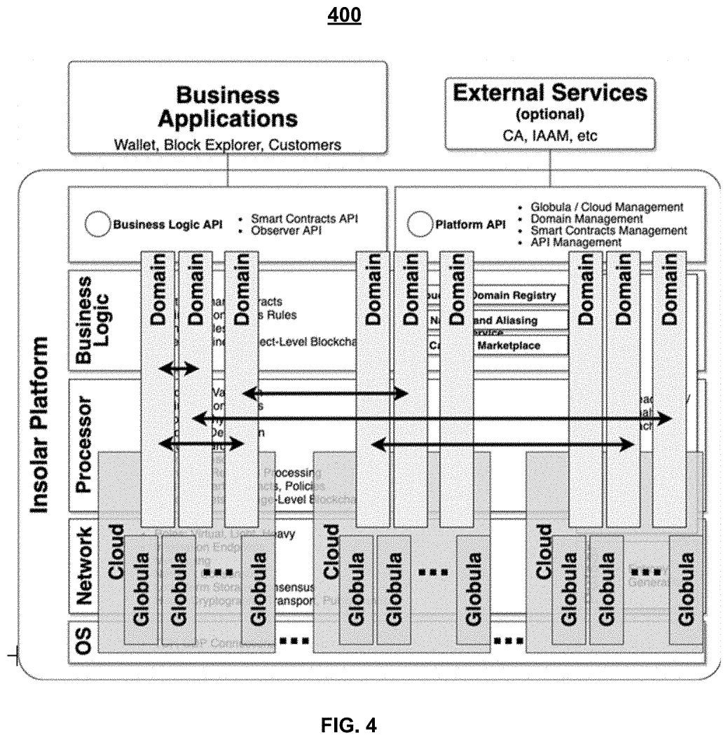

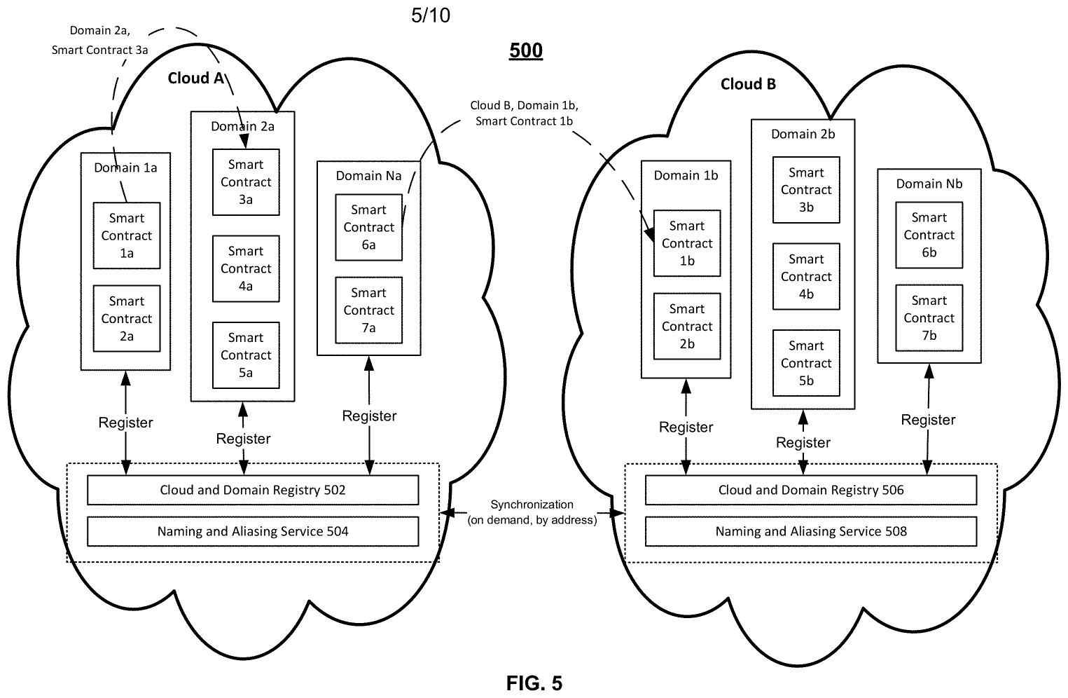

FIG. 4 is a block diagram of system 400 illustrating domains on multiple clouds on the Insolar platform, according to exemplary aspects of the present disclosure. System 400 depicts multiple clouds, each with their own respective domains. Contracts within domains are able to communicate with one another via an addressing system registry that makes them discoverable. Domains are also able to discover and exchange data between one another via an addressing system registry for domains. This communication can take place within one cloud or over multiple clouds (will be discussed in greater detail in FIG. 5).

The cloud (e.g., an instance of the Insolar platform) registers domains, enabling interaction between smart contracts contained by domains in different clouds, and allows governance logic and management procedures to be defined by each domain individually. For example, each domain can set up a voting procedure to change its rules, policies, and/or participants. Domains may define logic that can manage rules and requirements applied to validation, enabling business logic and transaction value to control consensus type and the number of validating nodes of the transaction. Examples of this control include balancing processing costs against uninsured risks and processing speed against operational risk. It should be noted that the application of relevant consensus procedures via domain policy is not limited to blockchain logic—a domain can allow changes to be initiated by legal procedures and court orders, or issues can be escalated to support or arbitrage.

FIG. 5 is a block diagram of system 500 illustrating communication over multiple clouds, according to exemplary aspects of the present disclosure. As mentioned previously, clouds and domains may communicate with other clouds and domains, respectively. This communication is made possible by registries within respective clouds, namely cloud and domain registry 502 and 506. The respective registries are kept synchronized for cloud-to-cloud communication. Within Domains are specific custom smart contracts and these contracts are also discoverable by an addressing system.

In order to call a smart contract within a different cloud (e.g., for smart contract 6a to call smart contract 1b), a mnemonic cloud address of the cloud (e.g., cloud B) where the contract (e.g., smart contract 1b) is situated, the corresponding mnemonic domain address and the mnemonic smart contract address within the domain are needed (e.g., of domain 1b and smart contract 1b). For example, when the address of Cloud B is registered in Cloud A, the addressing system receives (e.g., from a user), “Cloud A=physical address x.y.z”. Following this, the Cloud and Domain Registry (CDR) 502 and Naming and Aliasing Service (NAS) 504 become synchronized between clouds and domains (i.e., with CDR 506 and NAS 508, respectively) and one is subsequently able to make calls using a simplified identifier. The simplified identifier may be a name that follows a similar hierarchy to the world wide web addressing system, where the cloud address is the top level, the domain is second and the smart contract address is the third level (e.g., cloud.domain.smart-contract). Consider a commodity trade in which the payment leg may be tied to functionality provided by a domain different from the one that the trade itself lives in. In such a case, a smart contract from a different domain/cloud may need to be called. Smart contract 1a, for example, may be called directly from the application layer (e.g., some application running on a user's computer, or some external server). Smart contract 1a may represent a trade object, while smart contract 3a may represent specific payment object.

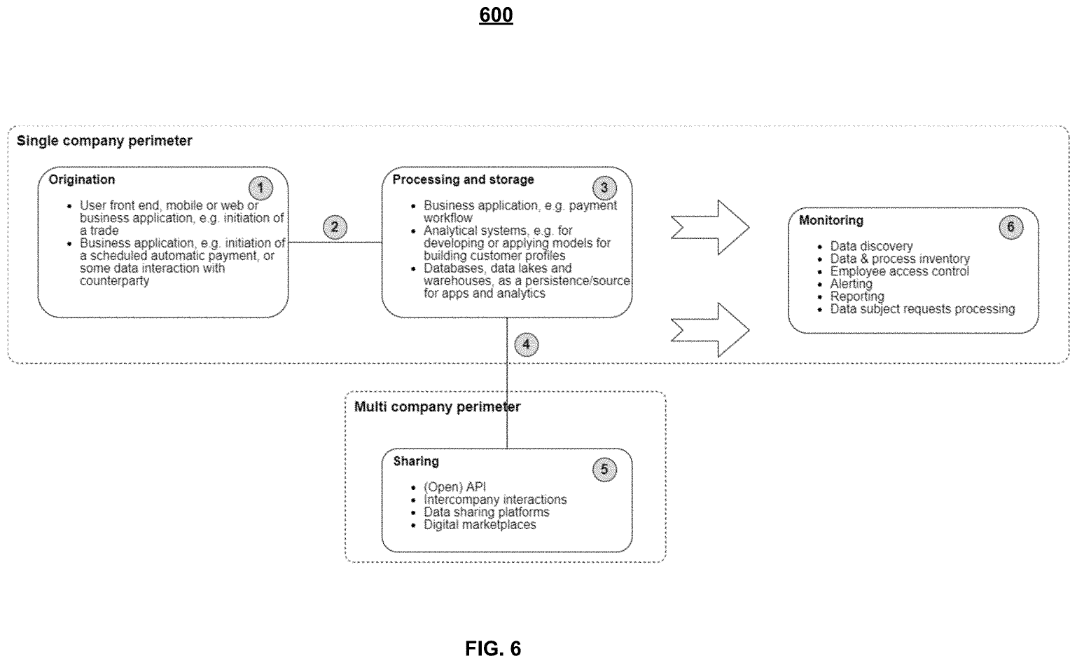

FIG. 6 is a block diagram of system 600 implementing a personal data privacy solution. System 600 is split into six sections. The first section represents origination points, which comprises the user front end or a business application. This section is where new business events are generated and the new data is created, be it purely personal data or business transactions like orders or trades. The second section represents integrations, which comprises messages that travel among different parts of the processing infrastructure.

The third section represents processing and storage, which comprises applications that process and analyze events and their data, and/or retain them for further analysis and processing. The fourth section represents sharing venues such as integrations with external counterparts of a company. The fifth section represents sharing. Sharing comprises various shared multi-party data pools (common and private) created through an API or other communication means, data sharing platforms, and digital marketplaces.

The sixth section represents monitoring. This section comprises facilities that help in (1) discovering structured and unstructured data that resides within a company perimeter and goes through communication venues, (2) tools for controlling access to different parts of the infrastructure, (3) alerting and reporting means that monitor and react to different anomalies in the data.

The existing privacy tools are mostly focused on section six (i.e., they are dealing mostly with the results of events that already happened and special efforts are needed to correct whatever happened without proper consent). The Insolar platform and in particular the privacy domain described in the present disclosure cover the business events and their data as they are being captured and handled at sections 1-5.

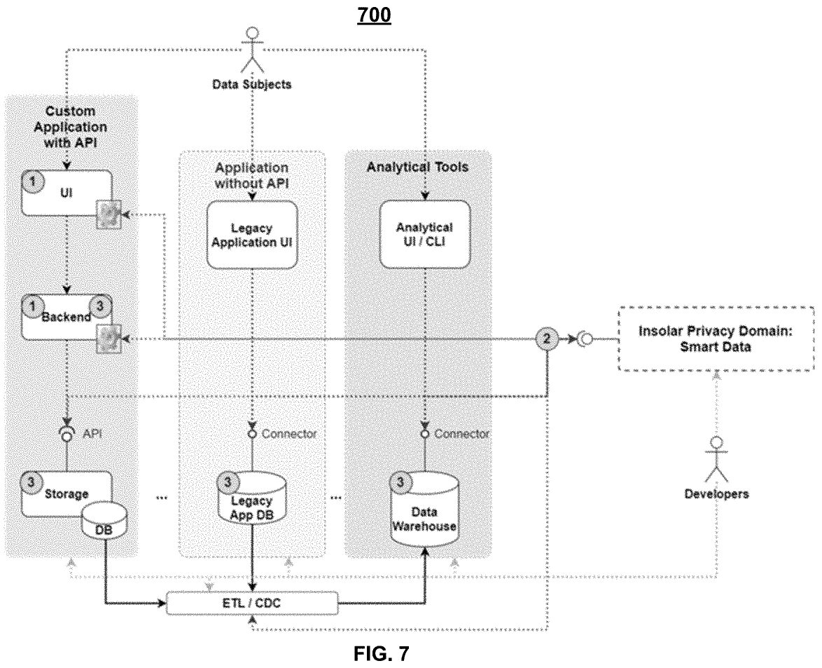

FIG. 7 is a block diagram 700 illustrating interactions with the Insolar Privacy Domain by data subjects and developers. System 700 embeds calling of the Insolar Privacy Domain (IPD) API into the custom built applications in the course of ongoing business processes. Examples of the processes include: order creation in e-commerce, automatic payment processing, data sharing.

IPD stores metadata of data subjects, provides online automatic consent checks and other mandated logic, and facilitates data locality and retention. The Insolar platform and its domains realize the mechanism for that is called “smart data”.

Custom plugins are embedded in the application frontends (e.g., web pages or customized UIs) using a software development kit (SDK) that developers may use to embed privacy into their code. The UI talks to the Insolar platform whenever a user (data subject or client's employee) creates or alters some object—for example, an order.

Similarly, when an object (e.g., an order in an e-commerce shop) is processed by the backend, IPD is called through the API. In some aspects, developers embed that into their code with the help of the SDK. In turn, an order may originate other objects (e.g., automatic payments) during the life cycle. When that happens, IPD can be called as well through the special API.

To facilitate realization of locality and retention policies, IPD may communicate with the data storage layer. IPD connects either through the API provided by the application or (if there is no API available) directly to the data source. For the latter case, additional significant efforts go into the discovery of the data source's structure.

As shown in FIG. 7, ETL, which comprises steps extract, transform, and load, is used to blend data associated with a data subject received from two sources: the application without API and the custom application with API. ETL is used specifically to build a data warehouse on which analytical tools (using analytical UI/command line interface (CLI)) are executed. Change data capture (CDC) is a process that captures changes made in a database (e.g., legacy app database), and replicates them to a destination such as the data warehouse.

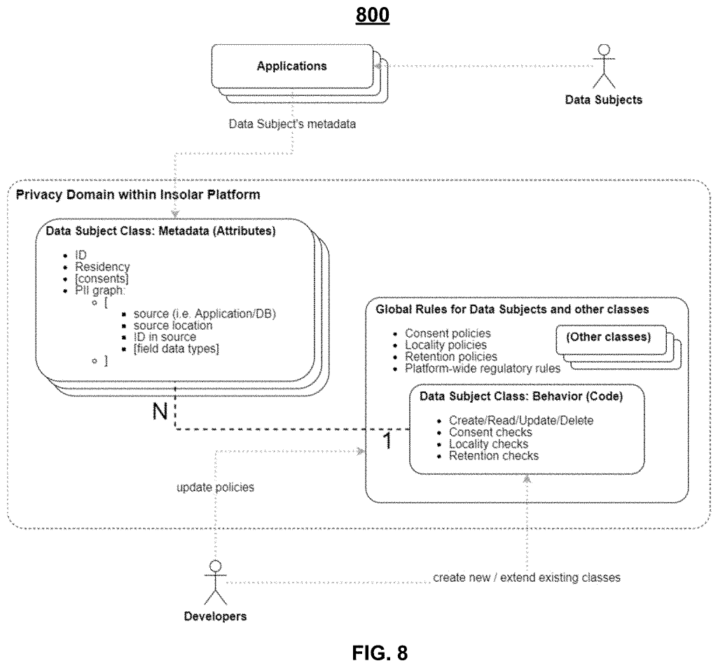

FIG. 8 is a block diagram 800 of smart data. From the developer perspective, the Insolar platform is a distributed computing system. Its programs are objects in classical object oriented programming as they contain both attributes (data) and methods (behavior implemented in code). Any object is accessed through the methods only, and it performs self-checks and self-updates on any invocation of any method.

Within the platform, there are several layers of management. Firstly, object data is stored separately from object code. Thus, platform updates the data separately from the code. Second, many instances of objects refer to the single instance of code and objects have a single set of behaviors attached to each of them. Thus, a single code update changes the behavior of multiple objects. Lastly, domains are “super-programs” governing other programs (e.g., regulation domains governing default behavior of the subject classes). Thus, default policies for data locality and data retention may be imposed on objects without directly affecting their code.

Developers handle these management abstractions, as well as with pre-built sets of extendable classes like data subject. Insolar Privacy Domain registers any action associated with the data subject, such as from which system it originated, what data types were involved, which fields were actually changed. In part, this metadata represents a graph of where the actual personal data of the particular data subject is located, and which places must be visited to retrieve or amend or delete the data.

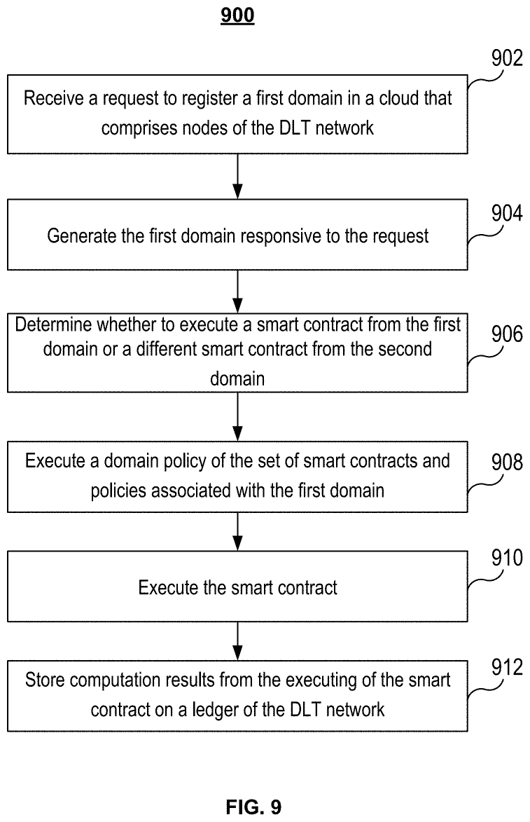

FIG. 9 is a flow diagram of method 900 for governing domain-based smart contract execution in a DLT network. At 902, method 900 comprises receiving a request to register a first domain in a cloud that comprises nodes of the DLT network. At 904, method 900 comprises generating the first domain responsive to the request, wherein the first domain comprises a set of smart contracts and policies for a first subset of the nodes and a pre-existing second domain in the cloud comprises a different set of smart contracts and policies for a second subset of the nodes. At 906, method 900 comprises determining whether to execute a smart contract from the first domain or a different smart contract from the second domain. In some aspects, this involves analyzing a request and determining which domain, from a plurality of domains comprising the first domain and the second domain, should serve the request. At 908, method 900 comprises executing a domain policy of the set of smart contracts and policies associated with the first domain in response to determining to execute the smart contract from the first domain, wherein the domain policy determines data privacy settings for the smart contract. At 910, method 900 comprises executing the smart contract. At 912, method 900 comprises storing computation results from the executing of the smart contract on a ledger of the DLT network.

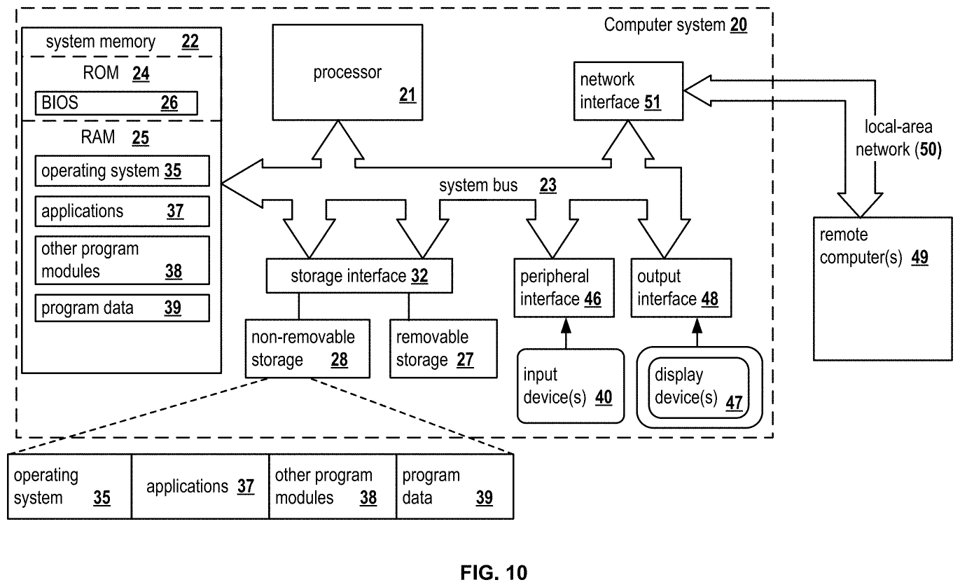

FIG. 10 is a block diagram illustrating a computer system 20 on which aspects of systems and methods for governing domain-based smart contract execution in a DLT network may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for governing domain-based smart contract execution in a DLT network, the method comprising:
receiving a request to register a first domain in a cloud that comprises nodes of the DLT network;
generating the first domain responsive to the request, wherein the first domain comprises a set of smart contracts and policies for a first subset of the nodes and wherein a pre-existing second domain in the cloud comprises a different set of smart contracts and policies for a second subset of the nodes;
determining whether to execute a smart contract from the first domain or a different smart contract from the second domain;
in response to determining to execute the smart contract from the first domain, executing a domain policy of the set of smart contracts and policies associated with the first domain, wherein the domain policy determines data privacy settings for the smart contract;
executing the smart contract; and
storing computation results from the executing of the smart contract on a ledger of the DLT network.

2. The method of claim 1, wherein the domain policy further defines onboarding and membership rules for the first domain.

3. The method of claim 1, wherein the domain policy further defines security policies comprising information on at least one of: access rights, authentication settings, authorization, and data sharing.

4. The method of claim 1, wherein the domain policy defines rules of consent and regulation-dependent personal data processing.

5. The method of claim 4, wherein the consent and regulation-dependent personal data processing comprises storing data in a particular geographic location, data retention or sharing the data with third parties.

6. The method of claim 1, wherein the domain policy further defines regulatory mechanisms indicating particular data that may be disclosed to smart contracts of the first domain and data that may be erased or scrambled on the ledger.

7. The method of claim 1, wherein the domain policy further defines contract policies comprising rules for adoption, exclusion, and amendment of smart contracts.

8. The method of claim 1, wherein the domain policy further defines dynamic consensus rules for adjusting required liability to validate versus defined value at risk of an operation.

9. The method of claim 1, wherein the domain policy further defines metadata governance such as registries of the nodes, contracts, and reference data.

10. The method of claim 1, wherein the domain policy further defines storage policies for processing and storing particular data.

11. A system for governing domain-based smart contract execution in a DLT network, the system comprising:
a hardware processor configured to:
receive a request to register a first domain in a cloud that comprises nodes of the DLT network;
generate the first domain responsive to the request, wherein the first domain comprises a set of smart contracts and policies for a first subset of the nodes and wherein a pre-existing second domain in the cloud comprises a different set of smart contracts and policies for a second subset of the nodes;
determine whether to execute a smart contract from the first domain or a different smart contract from the second domain;
in response to determining to execute the smart contract from the first domain, execute a domain policy of the set of smart contracts and policies associated with the first domain, wherein the domain policy determines data privacy settings for the smart contract;
execute the smart contract; and
store computation results from the executing of the smart contract on a ledger of the DLT network.

12. The system of claim 11, wherein the domain policy further defines onboarding and membership rules for the first domain.

13. The system of claim 11, wherein the domain policy further defines security policies comprising information on at least one of: access rights, authentication settings, authorization, and data sharing.

14. The system of claim 11, wherein the domain policy defines rules of consent and regulation-dependent personal data processing.

15. The system of claim 14, wherein the consent and regulation-dependent personal data processing comprises storing data in a particular geographic location, data retention or sharing the data with third parties.

16. The system of claim 11, wherein the domain policy further defines regulatory mechanisms indicating particular data that may be disclosed to smart contracts of the first domain and data that may be erased or scrambled on the ledger.

17. The system of claim 11, wherein the domain policy further defines contract policies comprising rules for adoption, exclusion, and amendment of smart contracts.

18. The system of claim 11, wherein the domain policy further defines dynamic consensus rules for adjusting required liability to validate versus defined value at risk of an operation.

19. The system of claim 11, wherein the domain policy further defines metadata governance such as registries of the nodes, contracts, and reference data.

20. A non-transitory computer readable medium storing thereon computer executable instructions for governing domain-based smart contract execution in a DLT network, including instructions for:
receiving a request to register a first domain in a cloud that comprises nodes of the DLT network;
generating the first domain responsive to the request, wherein the first domain comprises a set of smart contracts and policies for a first subset of the nodes and wherein a pre-existing second domain in the cloud comprises a different set of smart contracts and policies for a second subset of the nodes;
determining whether to execute a smart contract from the first domain or a different smart contract from the second domain;
in response to determining to execute the smart contract from the first domain, executing a domain policy of the set of smart contracts and policies associated with the first domain, wherein the domain policy determines data privacy settings for the smart contract;
executing the smart contract; and
storing computation results from the executing of the smart contract on a ledger of the DLT network.
